(19) United States
(12) Patent Application Publication
(10) Pub. No.: US 2022/0215340 A1
(43) Pub. Date: Jul. 7, 2022

(54) DISTRIBUTED REGISTER PERISHABLE TRACKER ENGINE

(71) Applicant: BANK OF AMERICA CORPORATION, Charlotte, NC (US)

(72) Inventors: Lee Ann Proud, Ponte Vedra, FL (US); Naoll Addisu Merdassa, Chakopee, MN (US)

(73) Assignee: BANK OF AMERICA CORPORATION, Charlotte, NC (US)

(21) Appl. No.: 17/140,823

(22) Filed: Jan. 4, 2021

(51) Int. Cl. G06Q 10/08

(52) U.S. Cl. CPC G06Q 10/08355; G06Q 10/0832; G06F 16/1834; G06Q 10/0833; G06Q 10/0838

(57) ABSTRACT

Embodiments of the invention are directed to a system that utilizes a distributed register integrate network for offer proof of location for perishable product distribution to entity locations. The system provides an entity platform for tracking perishables, performing analytics on perishable ordering and logistics, and providing retail distribution prior to perishable expiration.

### BACKGROUND

Distributed registers are a growing, highly-adaptive new technology already being implemented across multiple industries. Due to the unique characteristics inherent to the distributed register structure, users must approve transactions for the transactions to be saved as a block on the register. However, sometimes users are not immediately available for approval of the transaction, thus a delay occurs in the posting of the transaction on the resister. As a result, there exists a need for a new distributed register architecture that overcomes the challenges of the conventional posting methods associated with perishable product distribution networks.

### BRIEF SUMMARY

The following presents a simplified summary of one or more embodiments of the invention in order to provide a basic understanding of such embodiments. This summary is not an extensive overview of all contemplated embodiments, and is intended to neither identify key or critical elements of all embodiments, nor delineate the scope of any or all embodiments. Its sole purpose is to present some concepts of one or more embodiments in a simplified form as a prelude to the more detailed description that is presented later.

In distributed register network systems, transaction will be to passed to all node users from block chain. In case of private distributed registers, if user nodes are spread across multiple locations and various countries then immediate responses from each node is challenging.

Embodiments of the invention are directed to a system that utilizes a distributed register integrate network for offer proof of location for perishable product distribution to entity locations. The system provides an entity platform for tracking perishables, performing analytics on perishable ordering and logistics, and providing retail distribution prior to perishable expiration. The invention builds out a perishable tracking distributed network for tracking products/services that have shelf life. The system identifies users and entities distributing perishable products and link them in the distributed network. In some embodiments, entities include manufacturer, distribution center, or the like. In some embodiments, user includes brick and mortar retail store selling the perishable product.

The system may generate a block on distributed ledger for tracking location of perishable product. The blocks could be generated on a time interval, mileage interval, location, or the like. The system may then perform consensus of the block generation on the distributed ledger. The system provides a platform for users and entities visualization of distributed ledger and location of perishable products in transit relative to shelf life of product. Furthermore, the system performs data routing configuration and schedules for future perishable product distribution timing based on distributed network historic data.

Embodiments of the present invention address these and/or other needs by providing an innovative system, method and computer program product for an intelligent perishable tracking engine, the invention comprising: identifying entities distributing perishables to one or more users; authenticating the entities and the one or more users to a distributed register of the plurality of distributed registers associated with the intelligent perishable tracking engine and link the entities with the one or more users receiving the perishables; assigning each of the one or more users and each distribution vehicle to a node of the plurality of nodes; generating a consensus block on the distributed register identifying a time and location of the perishables being distributed to the one or more users; providing graphical platform for the one or more users and the entities to visualize the distributed register and a real-time location of the perishables in transit; performing learning analytics to the distributed registers of previous perishable transportations; and generating data routing configurations and schedules for future perishable distributions including routing and delivery logistics.

In some embodiments, generating data routing configurations and schedules for future perishable distributions including routing and delivery logistics comprises delivery of the perishable to the user, wherein the perishable has an extended shelf-life based on the routing and delivery logistics.

In some embodiments, generating the consensus block on the distributed register identifying a time and location of the perishables being distributed to the one or more users, further comprises generating a consensus block based on a time interval and mileage interval of the distribution vehicle.

In some embodiments, a consensus block is generated by the distribution vehicle confirming a location and one or more individuals confirming the distribution vehicle location via visualization or location monitoring of the distribution vehicle.

In some embodiments, linking the entities with the one or more users receiving the perishables further comprises linking the entities, the one or more users, and the distribution vehicle for delivery of the perishables into the distributed register, wherein the distributed register is a private distributed register accessible by only the entities, the one or more users, and the distribution vehicle associated with delivery of the perishables.

In some embodiments, the distribution vehicle is assigned to transport the perishables from the entity to one or more users.

In some embodiments, generating a consensus further comprises receiving a request requiring immediate review and consensus for posting further comprises receiving a request for posting a transaction on a private distributed resister network system.

In some embodiments, learning analytics further comprise an artificial intelligence (AI) data aggregator engine to dynamically identify data routing configurations and schedules for deliver logistics

The features, functions, and advantages that have been discussed may be achieved independently in various embodiments of the present invention or may be combined with yet other embodiments, further details of which can be seen with reference to the following description and drawings.

### BRIEF DESCRIPTION OF THE DRAWINGS

Having thus described embodiments of the invention in general terms, reference will now be made to the accompanying drawings, wherein:

FIG. 1 provides a distributed register intelligent perishable tracking system environment, in accordance with one embodiment of the invention;

FIG. 2 provides a block diagram of a perishable tracking distributed network system, in accordance with one embodiment of the invention;

FIG. 3A provides a centralized database architecture environment, in accordance with one embodiment of the invention;

FIG. 3B provides a high level distributed register system environment architecture, in accordance with one embodiment of the invention;

FIG. 4 provides a high level process flow illustrating the perishable tracking distributed network process, in accordance with one embodiment of the invention;

FIG. 5 provides a block diagram illustrating identification and logistical tracking with the perishable tracking distributed network, in accordance with one embodiment of the invention; and

FIG. 6 provides a high level process map illustrating logistic change recommendations based on perishable tracking, in accordance with one embodiment of the invention.

### DETAILED DESCRIPTION OF EMBODIMENTS OF THE INVENTION

Embodiments of the present invention will now be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure will satisfy applicable legal requirements. Like numbers refer to elements throughout. Where possible, any terms expressed in the singular form herein are meant to also include the plural form and vice versa, unless explicitly stated otherwise. Also, as used herein, the term “a” and/or “an” shall mean “one or more,” even though the phrase “one or more” is also used herein. Furthermore, when it is said herein that something is “based on” something else, it may be based on one or more other things as well. In other words, unless expressly indicated otherwise, as used herein “based on” means “based at least in part on” or “based at least partially on.”

Furthermore, as used herein the term “user device” may refer to any device that employs a processor and memory and can perform computing functions, such as a personal computer or a mobile device, wherein a mobile device is any mobile communication device, such as a cellular telecommunications device (i.e., a cell phone or mobile phone), personal digital assistant (PDA), a mobile Internet accessing device, or other mobile device. Other types of mobile devices may include portable digital assistants (PDAs), pagers, wearable devices, mobile televisions, gaming devices, laptop computers, cameras, video recorders, audio/video player, radio, global positioning system (GPS) devices, or any combination of the aforementioned. In some embodiments, a device may refer to an entity's computer system, platform, servers, databases, networked devices, or the like. The device may be used by the user to access the system directly or through an application, online portal, internet browser, virtual private network, or other connection channel. The device may be a computer device within a network of connected computer devices that share one or more network storage locations.

As used herein, the term “computing resource” or “computing hardware” may be used to refer to elements of one or more computing devices, networks, or the like available to be used in the execution of tasks or processes. A computing resource may include processor, memory, or network bandwidth and/or power used for the execution of tasks or processes. A computing resource may be used to refer to available processing, memory, and/or network bandwidth and/or power of an individual computing device as well a plurality of computing devices that may operate as a collective for the execution of one or more tasks (e.g., one or more computing devices operating in unison or nodes of a distributed computing cluster).

A “user” as used herein may refer to any individual that may be a retailer that is receiving a perishable product for distribution at a retail location. A user may be associated with an entity and an entity may have multiple user locations for distribution of the perishable product. In some embodiments, a user may have access to a computing device user, a phone user, a mobile device application user, and may be an individual such as a system operator, database manager, a support technician, and/or employee of an entity.

In accordance with embodiments of the invention, the term “entity” may be used to include any organization or collection of users that may interact with the system and/or a distributed register system. An entity may refer to a group of users, group of retailers, business, company, or other organization that either maintains or operates the system or requests use and accesses the system. The terms “financial institution” and “financial entity” may be used to include any organization that processes financial transactions including, but not limited to, banks, credit unions, savings and loan associations, investment companies, stock brokerages, management firms, insurance companies and the like. In specific embodiments of the invention, use of the term “bank” is limited to a financial entity in which account-bearing customers conduct financial transactions, such as account deposits, withdrawals, transfers and the like. In other embodiments, an entity may be a business, organization, a government organization or the like that is not a financial institution.

To “monitor” is to watch, observe, or check something for a special purpose over a period of time. The “monitoring” may occur periodically over the period of time, or the monitoring may occur continuously over the period of time. In some embodiments, a system may actively monitor a database or data archive, wherein the system reaches out to the database and watches, observes, or checks the database for changes, updates, and the like. In other embodiments, a system may passively monitor a database, wherein the database provides information to the system and the system then watches, observes, or checks the provided information. In some embodiments a system, application, and/or module (such as the robotic process automation module and/or the entity platform described herein) may monitor a user input into the system. In further embodiments, the system may store said user input during an interaction in order to substantially replicate said user input at another time.

As used herein, a “connection” or an “interaction” may refer to any communication between one or more users, one or more entities or institutions, and/or one or more devices, nodes, clusters, or systems within the system environment described herein. For example, an interaction may refer to a transfer of data between systems or devices, an accessing of stored data by one or more devices, a transmission of a requested task, a reporting and correction of an error, or the like. In another example, an interaction may refer to a user interaction with a user device through a user interface in order to connect or communicate with an entity and/or entity system to complete an operation (e.g., request a transfer of funds from an account, complete a form, or the like).

The term “distributed register” as used herein, refer to an electronic ledger, such as a distributed register or blockchain of data records which are authenticated by a federated consensus protocol. Multiple computer systems within the distributed register, referred to herein as “nodes” or “compute nodes,” each comprise a copy of the entire ledger of records. Nodes may write a data “block” to the distributed register, the block comprising data regarding a transaction, said blocks further comprising data and/or metadata. In some embodiments, only miner nodes may write transactions to the distributed register. In other embodiments, all nodes have the ability to write to the distributed register. In some embodiments, the block may further comprise a time stamp and a pointer to the previous block in the chain. In some embodiments, the block may further comprise metadata indicating the node that was the originator of the transaction. In this way, the entire record of transactions is not dependent on a single database which may serve as a single point of failure; the distributed register will persist so long as the nodes on the distributed register persist. A “private distributed register” or “permissioned distributed register” is a distributed register in which only authorized nodes may access the distributed register. In some embodiments, nodes must be authorized to write to the distributed register. In some embodiments, nodes must also be authorized to read from the distributed register. Once a transactional record is written to the distributed register, it will be considered pending and awaiting authentication by the miner nodes in the distributed register.

A “block” as used herein may refer to one or more records of a file with each record comprising data for transmission to a server. In some embodiments, the term record may be used interchangeably with the term block to refer to one or more transactions or data within a file being transmitted. In particular, the distributed register begins with a genesis block and is subsequently lengthened by appending blocks in series to the genesis block. Generally, the data within each block within the distributed register may not be modified by the nodes of the distributed register; data may only be added through the addition of a block to the last block in the distributed register. Each block added to the distributed register may comprise a timestamp and a pointer to the previous block in the distributed register. In this way, the distributed register may provide an immutable record of data records over a period of time. In some embodiments, in order for a new block to be added to the distributed register, a pending data record may be proposed to be added to the distributed register. The nodes may then, via a “consensus algorithm” or “consensus mechanism,” come to a consensus as to the contents of the data in the distributed register. Once a consensus has been reached by the nodes that the pending data record is valid, the nodes append the data record to the last block in the distributed register. In this way, each node maintains a validated copy of the distributed register such that the distributed register may remain accessible even if one or more nodes become unavailable (e.g. a node is offline due to maintenance, malfunction, or the like) and may further account for divergence from the true copy of the distributed register which may occur at the node level (e.g. a copy of the distributed register on a particular node becomes invalid due to data corruption, malicious editing, and the like). In other words, the consensus mechanism ensures that, over time, each node hosts a copy of the distributed register that is consistent with the other nodes.

Embodiments of the invention as described herein may utilize one, several, or a combination (i.e. hybrid) of a number of different consensus algorithms to ensure the integrity of the data within the distributed register. In some embodiments, the consensus mechanism may be a “proof of work” (“PoW”) algorithm, in which the nodes perform a series of calculations to solve a cryptographic puzzle. For instance, in order to validate a pending data record, the nodes may be required to calculate a hash via a hash algorithm which satisfies certain conditions set by the system. Calculating a hash in this way may be referred to herein as “mining,” and thus a node performing the mining may be referred to as “miners” or “miner nodes.”

Embodiments of the invention provide a technical solution to a problem by utilizing distributed register systems in a nonconventional way. Unlike a more traditional centralized approach to distributed register regulation, wherein significant logistic delays that effect perishable product distribution, the present invention implements a change to the architecture of logistics of perishable product distribution for distribution to user nodes that are available in real-time for instant transaction review and consensus, thus eliminating delay and expiration of perishable products due to logistic and transportation.

In distributed register network systems, transaction will be to passed to all node users from block chain. In case of private distributed registers, if user nodes are spread across multiple locations and various countries then immediate responses from each node is challenging.

Embodiments of the invention are directed to a system that utilizes a distributed register integrate network for offer proof of location for perishable product distribution to entity locations. The system provides an entity platform for tracking perishables, performing analytics on perishable ordering and logistics, and providing retail distribution prior to perishable expiration. The invention builds out a perishable tracking distributed network for tracking products/services that have shelf life. The system identifies users and entities distributing perishable products and link them in the distributed network. In some embodiments, entities include manufacturer, distribution center, or the like. In some embodiments, user includes brick and mortar retail store selling the perishable product.

The system may generate a block on distributed ledger for tracking location of perishable product. The blocks could be generated on a time interval, mileage interval, location, or the like. The system may then perform consensus of the block generation on the distributed ledger. The system provides a platform for users and entities visualization of distributed ledger and location of perishable products in transit relative to shelf life of product. Furthermore, the system performs data routing configuration and schedules for future perishable product distribution timing based on distributed network historic data.

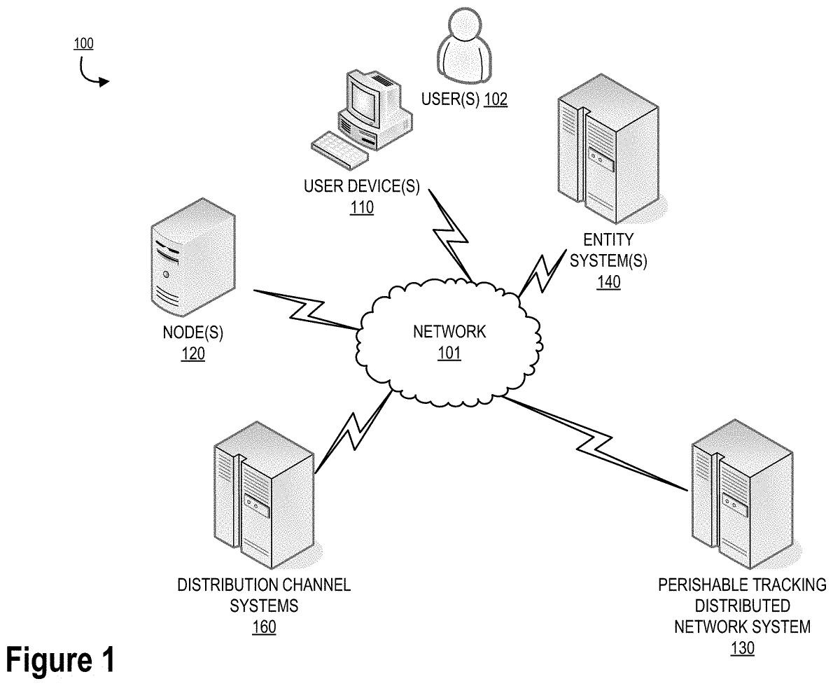

FIG. 1 provides a system that includes specialized systems and devices communicably linked across a distributive network of nodes required to perform the functions of implementing the perishable tracking engine as described herein. FIG. 1 provides a distributed register intelligent perishable tracking system environment 100, in accordance with one embodiment of the present invention.

As illustrated in FIG. 1, the perishable tracking distributed network system 130 is operatively coupled, via a network 101 to the user device 110, nodes 120, the entity system 140, and the distribution channel systems 160. In this way, the perishable tracking distributed network system 130 can send information to and receive information from the user device 110, nodes 120, entity system 140, and distribution channel systems 160. FIG. 1 illustrates only one example of an embodiment of the system environment 100, and it will be appreciated that in other embodiments one or more of the systems, devices, or servers may be combined into a single system, device, or server, or be made up of multiple systems, devices, or servers.

The network 101 may be a system specific distributive network receiving and distributing specific network feeds and identifying specific network associated triggers. The network 101 may also be a global area network (GAN), such as the Internet, a wide area network (WAN), a local area network (LAN), or any other type of network or combination of networks. The network 101 may provide for wireline, wireless, or a combination wireline and wireless communication between devices on the network 101.

In some embodiments, the user 102 is an individual or entity that may be a retailer that is receiving a perishable product for distribution at a retail location. A user may be associated with an entity and an entity may have multiple user locations for distribution of the perishable product. In some embodiments, the user 102 has a user device 110, such as a mobile phone, tablet, or the like that may interact with and control the recordation and validation of blocks on the distributed register through interaction with the devices and systems of the environment 100. The user device 110 may generally include a processing device or processor communicably coupled to devices such as, a memory device, user output devices (for example, a user display device, or a speaker), user input devices (such as a microphone, keypad, touchpad, touch screen, and the like), a communication device or network interface device, a power source, and the like. The processing device may further include a central processing unit, input/output (I/O) port controllers, a graphics controller or GPU, a serial bus controller and a memory and local bus controller.

The processing device may include functionality to operate one or more software programs or applications, which may be stored in the memory device. For example, the processing device may be capable of operating applications such as the user application. The user application may then allow the user device 110 to transmit and receive data and instructions from the other devices and systems. The user device 110 comprises computer-readable instructions and data storage stored in the memory device, which in one embodiment includes the computer-readable instructions of a user application. In some embodiments, the user application allows a user 102 to access and/or interact with the environment 100.

The processing device may be configured to use the communication device to communicate with one or more other devices on a network 101 such as, but not limited to the perishable tracking distributed network system 130. In this regard, the communication device may include an antenna operatively coupled to a transmitter and a receiver (together a “transceiver”), modem. The processing device may be configured to provide signals to and receive signals from the transmitter and receiver, respectively. The signals may include signaling information in accordance with the air interface standard, cellular system of the wireless telephone network and the like, that may be part of the network. In this regard, the user device 110 may be configured to operate with one or more air interface standards, communication protocols, modulation types, and access types. By way of illustration, the user device 110 may be configured to operate in accordance with any of a number of first, second, third, and/or fourth-generation communication protocols and/or the like. For example, the user device 110 may be configured to operate in accordance with second-generation (2G) wireless communication protocols IS-136 (time division multiple access (TDMA)), GSM (global system for mobile communication), and/or IS-95 (code division multiple access (CDMA)), or with wireless communication protocols, such as Universal Mobile Telecommunications System (UMTS), CDMA2000, wideband CDMA (WCDMA) and/or time division-synchronous CDMA (TD-SCDMA), and/or the like.

The user device 110 may also include a memory buffer, cache memory or temporary memory device operatively coupled to the processing device. Typically, one or more applications, are loaded into the temporarily memory during use. As used herein, memory may include any computer readable medium configured to store data, code, or other information. The memory device may include volatile memory, such as volatile Random Access Memory (RAM) including a cache area for the temporary storage of data. The memory device 234 may also include non-volatile memory, which can be embedded and/or may be removable. The non-volatile memory may additionally or alternatively include an electrically erasable programmable read-only memory (EEPROM), flash memory or the like.

Though not shown in detail, the system further includes an entity system 140 (as illustrated in FIG. 1) which is connected to the user device 110, the nodes 120, the perishable tracking distributed network system 130, and the distribution channel systems 160 may be associated with one or more entities such as logistic entities, merchant entities, or the like. In this way, while only one entity system 140 is illustrated in FIG. 1, it is understood that multiple network systems may make up the system environment 100. The entity system 140 generally comprises a communication device, a processing device, and a memory device. The entity system 140 comprises computer-readable instructions stored in the memory device, which in one embodiment includes the computer-readable instructions of a financial institution application. The entity system 140 may communicate with the user device 110, the nodes 120, the perishable tracking distributed network system 130, distribution channel systems 160 to for example, complete and post transactions on the distributed register and track logistics of potentially perishable products.

The nodes 120 and distribution channel systems 160 comprise the same or similar features as the user device 110 and the entity system 140. In some embodiments, the nodes 120 may be user devices 110 forming a plurality of networked devices participating in a distributed register environment. The distribution channel systems 160 are may be maintained by an entity such as a regulatory agency or financial entity for regulating data on the distributed register and ensuring node review and processing health via the processes described herein.

It is understood that the servers, systems, and devices described herein illustrate one embodiment of the invention. It is further understood that one or more of the servers, systems, and devices can be combined in other embodiments and still function in the same or similar way as the embodiments described herein.

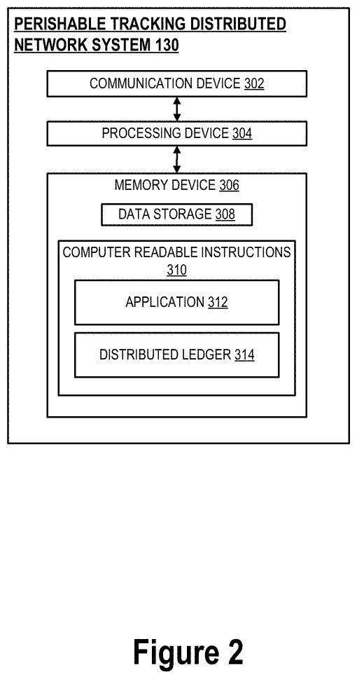

FIG. 2 provides a block diagram of the perishable tracking distributed network system 130, in accordance with one embodiment of the invention. The perishable tracking distributed network system 130 generally comprises a communication device 302, a processing device 304, and a memory device 306. As used herein, the term “processing device” generally includes circuitry used for implementing the communication and/or logic functions of the particular system. For example, a processing device may include a digital signal processor device, a microprocessor device, and various analog-to-digital converters, digital-to-analog converters, and other support circuits and/or combinations of the foregoing. Control and signal processing functions of the system are allocated between these processing devices according to their respective capabilities. The processing device may include functionality to operate one or more software programs based on computer-readable instructions thereof, which may be stored in a memory device.

The processing device 306 is operatively coupled to the communication device 302 and the memory device 306. The processing device 304 uses the communication device 302 to communicate with the network 101 and other devices on the network 101, such as, but not limited to the user device 110, the nodes 120, the entity system 140, and the distribution channel systems 160. As such, the communication device 302 generally comprises a modem, server, or other device for communicating with other devices on the network 101.

As further illustrated in FIG. 2, the perishable tracking distributed network system 130 comprises computer-readable instructions 310 stored in the memory device 306, which in one embodiment includes the computer-readable instructions 310 of a distributed register application 312. In some embodiments, the memory device 306 includes data storage 308 for storing data related to the system environment, but not limited to data created and/or used by the distributed register application 312.

Embodiments of the perishable tracking distributed network system 130 may include multiple systems, servers, computers or the like maintained by one or many entities. FIG. 2 merely illustrates one of those systems that, typically, interacts with many other similar systems to form the distributed register. The perishable tracking distributed network system 130 will be outlined below in more detail. In some embodiments, financial institution systems may be part of the distributed register. Similarly, in some embodiments, the perishable tracking distributed network system 130 is part of an entity system 140. In other embodiments, the entity system 140 is distinct from the perishable tracking distributed network system 130. The perishable tracking distributed network system 130 may communicate with the entity system 140 via a secure connection generated for secure encrypted communications between the two systems.

In one embodiment of the perishable tracking distributed network system 130 the memory device 306 stores, but is not limited to, a distributed register application 312 and a distributed ledger 314. In some embodiments, the distributed ledger 314 stores data including, but not limited to, at least portions of a transaction record. In one embodiment of the invention, both the distributed register application 312 and the distributed ledger 314 may associate with applications having computer-executable program code that instructs the processing device 304 to operate the network communication device 302 to perform certain communication functions involving described herein. In one embodiment, the computer-executable program code of an application associated with the distributed ledger 314 and distributed register application 312 may also instruct the processing device 304 to perform certain logic, data processing, and data storing functions of the application.

The processing device 304 is configured to use the communication device 302 to gather data, such as data corresponding to transactions, blocks or other updates to the distributed ledger 314 from various data sources such as other distributed register network system. The processing device 304 stores the data that it receives in its copy of the distributed ledger 314 stored in the memory device 306.

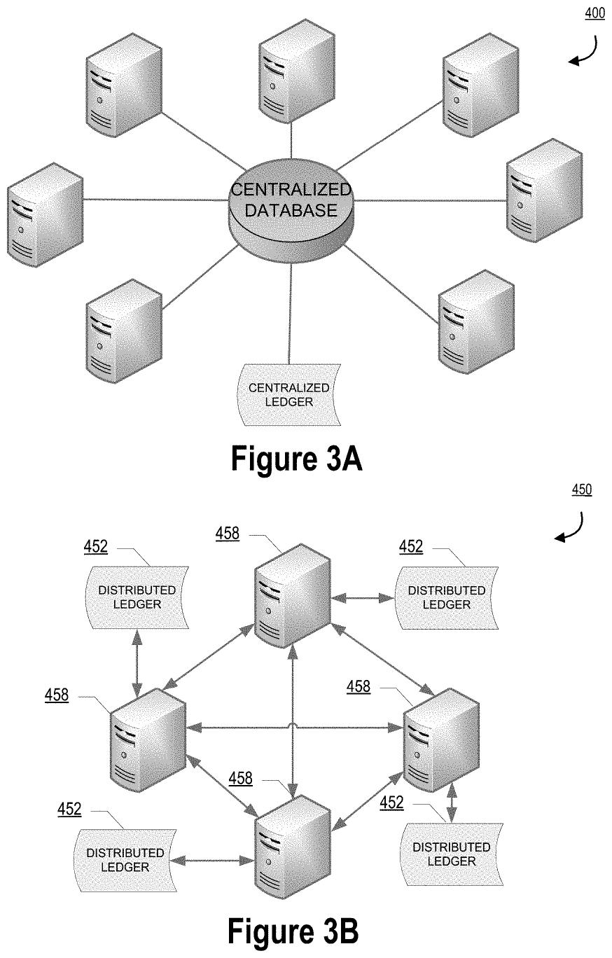

FIG. 3A illustrates a centralized database architecture environment 400, in accordance with one embodiment of the present invention. The centralized database architecture comprises multiple nodes from one or more sources and converge into a centralized database. The system, in this embodiment, may generate a single centralized ledger for data received from the various nodes. FIG. 3B provides a general distributed register system environment architecture 450, in accordance with one embodiment of the present invention. Rather than utilizing a centralized database of data for instrument conversion, as discussed above in FIG. 3A, various embodiments of the invention may use a decentralized distributed register configuration or architecture as shown in FIG. 3B.

A distributed register is a distributed database that maintains a list of data blocks, such as real-time resource availability associated with one or more accounts or the like, the security of which is enhanced by the distributed nature of the distributed register. A distributed register typically includes several nodes, which may be one or more systems, machines, computers, databases, data stores or the like operably connected with one another. In some cases, each of the nodes or multiple nodes are maintained by different entities. A distributed register typically works without a central repository or single administrator. One well-known application of a distributed register is the public ledger of transactions. The data blocks recorded in the distributed register are enforced cryptographically and stored on the nodes of the distributed register.

A distributed register provides numerous advantages over traditional databases. A large number of nodes of a distributed register may reach a consensus regarding the validity of a transaction contained on the transaction ledger. As such, the status of the instrument and the resources associated therewith can be validated and cleared by one participant.

The distributed register system typically has two primary types of records. The first type is the transaction type, which consists of the actual data stored in the distributed register. The second type is the block type, which are records that confirm when and in what sequence certain transactions became recorded as part of the distributed register. Transactions are created by participants using the distributed register in its normal course of business, for example, when someone sends cryptocurrency to another person, and blocks are created by users known as “miners” who use specialized software/equipment to create blocks. In some embodiments, the distributed register system is closed, as such the number of miners in the current system are known and the system comprises primary sponsors that generate and create the new blocks of the system. As such, any block may be worked on by a primary sponsor. Users of the distributed register create transactions that are passed around to various nodes of the distributed register. A “valid” transaction is one that can be validated based on a set of rules that are defined by the particular system implementing the distributed register. For example, in the case of cryptocurrencies, a valid transaction is one that is digitally signed, spent from a valid digital wallet and, in some cases that meets other criteria.

As mentioned above and referring to FIG. 3B, a distributed register system 450 is typically decentralized—meaning that a distributed ledger 452 (i.e., a decentralized ledger) is maintained on multiple nodes 458 of the distributed register 450. One node in the distributed register may have a complete or partial copy of the entire ledger or set of transactions and/or blocks on the distributed register. Transactions are initiated at a node of a distributed register and communicated to the various nodes of the distributed register. Any of the nodes can validate a transaction, add the transaction to its copy of the distributed register, and/or broadcast the transaction, its validation (in the form of a block) and/or other data to other nodes. This other data may include time-stamping, such as is used in cryptocurrency distributed registers. In some embodiments, the nodes 458 of the system might be financial institutions that function as gateways for other financial institutions. For example, a credit union might hold the account, but access the distributed system through a sponsor node.

Various other specific-purpose implementations of distributed registers have been developed. These include distributed domain name management, decentralized crowd-funding, synchronous/asynchronous communication, decentralized real-time ride sharing and even a general purpose deployment of decentralized applications.

However, in these standard distributed register systems, transaction will be to passed to all node users from block chain. In case of private distributed registers, if user nodes are spread across multiple locations and various countries then immediate responses from each node is challenging.

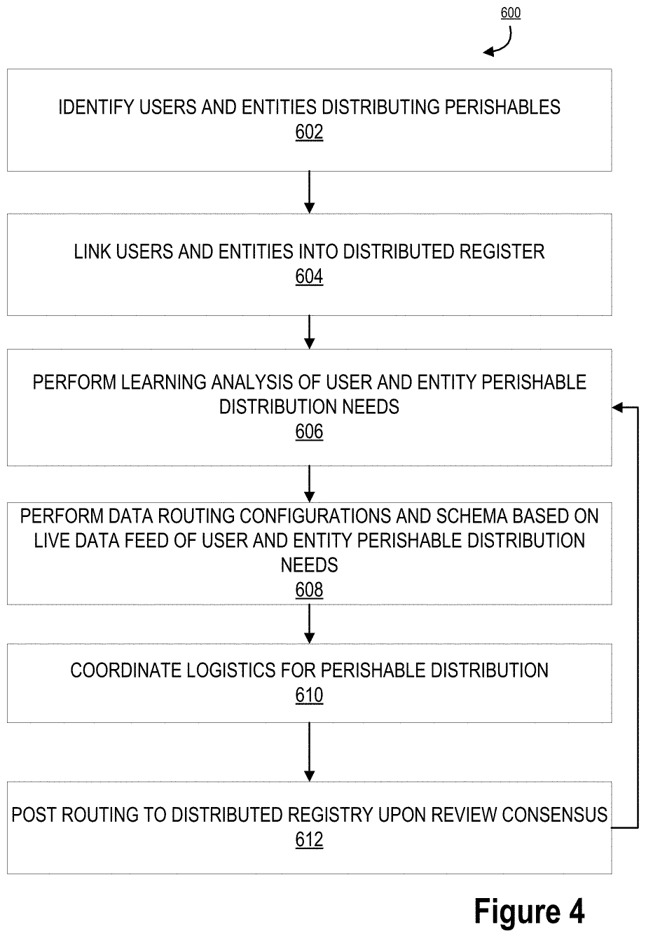

FIG. 4 provides a high level process flow illustrating the perishable tracking distributed network process 600, in accordance with one embodiment of the invention. As illustrated in block 602, the process 600 is initiated by identifying users and entities that are distributing perishables. Perishables may include any product or service that may have a shelf life at a user location. In this way, the product may have an expiration date that may make the product unusable for its intended purpose. The user may be a final recipient of the perishable or may be a retail store distributing the perishable to an end consumer.

The system may identify entities and users that are linked together in a supply chain distribution of perishables. The system may link the users and entities into a distributed register for the supply chain distribution and delivery of the perishable, as illustrated in block 604. This linkage may allow the users and entities that are in supply chain together to be linked and authenticated into a private distributed registry to visualize real-time location and management of perishable distribution and logistics.

The system may track the location of the perishables as they are being transported from the entity to the user. In this way, a block may be posted to the distributed registry based on a time interval, a mileage interval, or based on location target passage. As such, the system may track the distribution vehicle from the entity to the user and the location of that distribution vehicle during transit in order to real-time identify the location and projected arrival of a perishable. In this way, the system tracks the location of the perishables as they are being transported and allow for the user and entity to monitor the location in real-time of the perishables.

The process 600 may continue by performing learning analysis of user and entity perishable distribution needs for each entity and/or user, as illustrated in block 606. As illustrated in block 608, the process 600 performs data routing configurations and schema based on the live data feed of the user and entity perishable distribution needs. In this way, the system may perform machine learning analytics to track an amount of perishables needed, timing of when the are needed, location of the perishables that need to need to be transported, and appropriate transportation logistics to ensure fresh perishable arrival at the user.

Returning to block 604, when the process 600 links users and entities into the distributed register for a current perishable distribution, the system may continue to coordinate logistics for distribution of the current perishable, as illustrated in block 610. Finally, as illustrated in block 612, the process 600 is completed by posting the routing of the perishable distribution to the distributed register upon review consensus for user and entity visualization of the real-time distribution of the distribution. The system further provides for a backend feedback loop to block 606 and 608 to perform learning analysis of the user and entity perishable distribution needs and to perform data routing configurations and schema based on the live data feed from block 612.

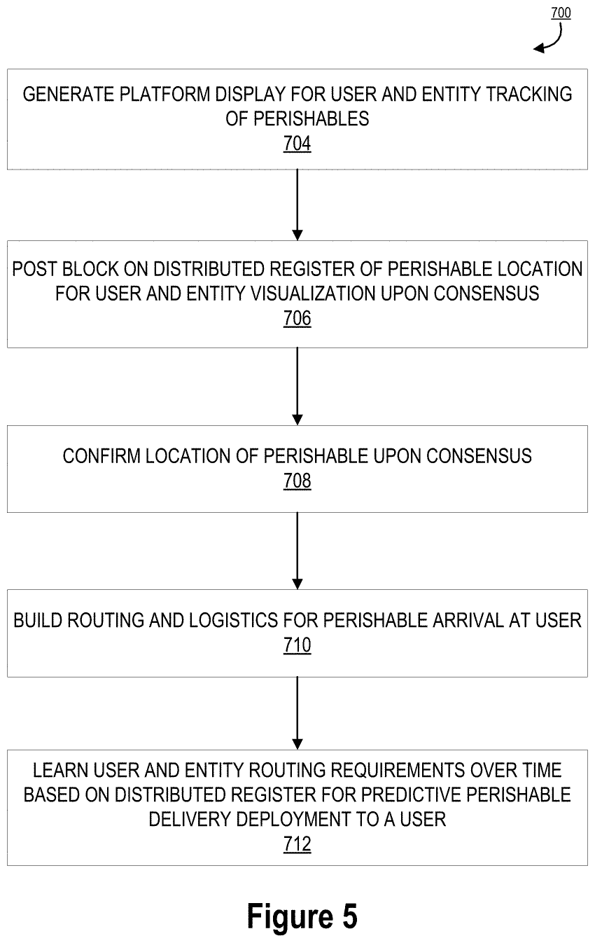

FIG. 5 provides a block diagram illustrating identification and logistical tracking with the perishable tracking distributed network 700, in accordance with one embodiment of the invention. As illustrated in block 704, the process 700 is initiated by generating a platform for display of user and entity tracking of perishables. In this way, each time a block is added to the distributed registry, the system presents an updated to the platform for user and entity display of the location of the perishable in transit and an expected arrival time of the perishable. Furthermore, the system may track and notify a user of the life span of the perishable upon arrival at the user, such that the user can prepare for product display in an appropriate time for end consumer consumption.

As illustrated in block 706, the process 700 continues by posting one or more blocks on a distributed register of the perishable location for user and entity visualization upon consensus of the nodes of the distributed register. The nodes may include a driver of the distribution vehicle confirming a location, a vehicle confirmation of location, individuals at or near the distribution vehicle confirming location, global position unit information, tracking of vehicle location information, or the like. Next, as illustrated in block 708, the process 700 continues by confirming the location of the perishable upon consensus being received. This confirmation of the location may be presented to the user and the entity to be able to visualize the real-time location of the perishables during delivery.

As illustrated in block 710, the process 700 continues to build routing and logistics for perishable arrival at the user for future perishable deliveries. In this way, the system utilizes machine learning to predict user future needs of perishable deliveries, quantities of perishables, and timing of an optimal delivery of the perishable. In this way, the system may be able to predict and calculate proper times and entity locations to pick up the perishables in order to arrive at the user location in time for consumer purchase prior to self-life expiration.

As illustrated in block 712, the process 700 continues by learning user and entity routing requirements over time based on the distributed register for predictive perishable deliver deployment to a user in the future.

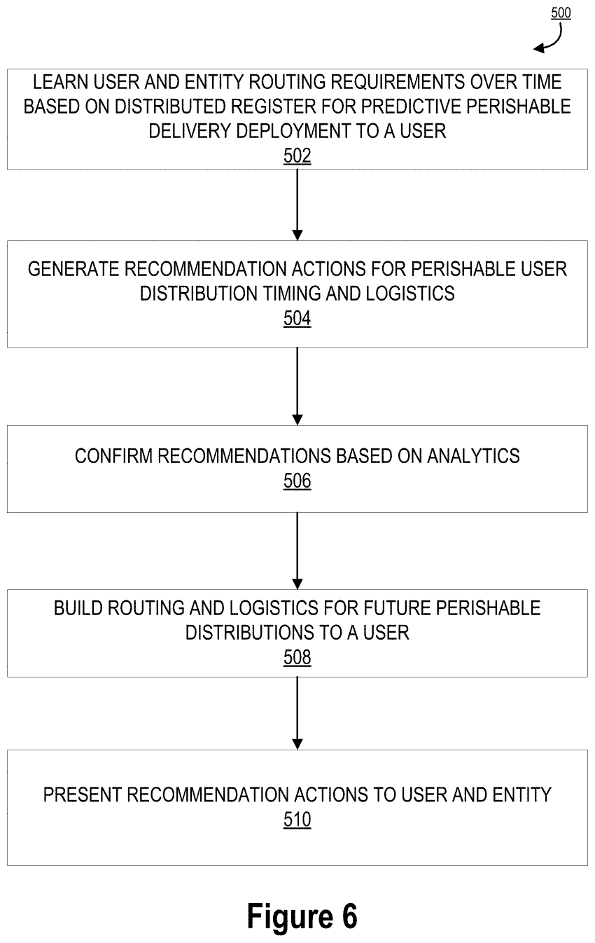

FIG. 6 provides a high level process map illustrating logistic change recommendations based on perishable tracking 500, in accordance with one embodiment of the invention. As illustrated in block 502, the process 500 is initiated by learning user and entity routing requirements over time based on the distributed register perishable tracker for predictive perishable delivery deployment to the user. In this way, the distributed ledger tracking technology allows for prevention of expiration of perishables.

Next, as illustrated in block 504, the process 500 continues by generating recommendation actions for perishable user distribution timing and logistics. In this way, using the past distributed registry routing, the system may predict a faster and more efficient way to deliver the perishable, such as a type of transportation, a timing of delivery, an entity to pick up the perishable, a rout to deliver the perishable, and/or timing on ordering the perishable. The recommendations may be determined based on machine learning of all previous tracking of all entities and users.

As illustrated in block 506, the process 500 continues by confirming the recommendations based on analytics. In this way, the system may perform additional analytics on the generated recommendations to confirm the most efficient logistics in order for the user to receive the correct number of perishables at the correct time for user to provide the perishable to the end consumer.

Next, as illustrated in block 508, the process 500 continues by building out the routing and logistics for future perishable distributions to a user. In this way, the system may communicate with the entity, distribution vehicle, and user in order to plan and execute the logistics for delivery of the perishable to the user on a correct time and with the correct amount.

As illustrated in block 510, the process 500 is completed by presenting the recommendation actions to the user, distribution vehicle, and entity to complete the future perishable distribution.

Embodiments of the invention provide a technical solution to a problem by utilizing distributed register systems in a nonconventional way. Unlike a more traditional centralized approach to distributed register regulation, wherein significant logistic delays that effect perishable product distribution, the present invention implements a change to the architecture of logistics of perishable product distribution for distribution to user nodes that are available in real-time for instant transaction review and consensus, thus eliminating delay and expiration of perishable products due to logistic and transportation.

In distributed register network systems, transaction will be to passed to all node users from block chain. In case of private distributed registers, if user nodes are spread across multiple locations and various countries then immediate responses from each node is challenging.

Embodiments of the invention are directed to a system that utilizes a distributed register integrate network for offer proof of location for perishable product distribution to entity locations. The system provides an entity platform for tracking perishables, performing analytics on perishable ordering and logistics, and providing retail distribution prior to perishable expiration. The invention builds out a perishable tracking distributed network for tracking products/services that have shelf life. The system identifies users and entities distributing perishable products and link them in the distributed network. In some embodiments, entities include manufacturer, distribution center, or the like. In some embodiments, user includes brick and mortar retail store selling the perishable product.

The system may generate a block on distributed ledger for tracking location of perishable product. The blocks could be generated on a time interval, mileage interval, location, or the like. The system may then perform consensus of the block generation on the distributed ledger. The system provides a platform for users and entities visualization of distributed ledger and location of perishable products in transit relative to shelf life of product. Furthermore, the system performs data routing configuration and schedules for future perishable product distribution timing based on distributed network historic data.

As will be appreciated by one of ordinary skill in the art, the present invention may be embodied as an apparatus (including, for example, a system, a machine, a device, a computer program product, and/or the like), as a method (including, for example, a business process, a computer-implemented process, and/or the like), or as any combination of the foregoing. Accordingly, embodiments of the present invention may take the form of an entirely software embodiment (including firmware, resident software, micro-code, and the like), an entirely hardware embodiment, or an embodiment combining software and hardware aspects that may generally be referred to herein as a “system.” Furthermore, embodiments of the present invention may take the form of a computer program product that includes a computer-readable storage medium having computer-executable program code portions stored therein. As used herein, a processor may be “configured to” perform a certain function in a variety of ways, including, for example, by having one or more special-purpose circuits perform the functions by executing one or more computer-executable program code portions embodied in a computer-readable medium, and/or having one or more application-specific circuits perform the function. As such, once the software and/or hardware of the claimed invention is implemented the computer device and application-specific circuits associated therewith are deemed specialized computer devices capable of improving technology associated with the in authorization and instant integration of a new credit card to digital wallets.

It will be understood that any suitable computer-readable medium may be utilized. The computer-readable medium may include, but is not limited to, a non-transitory computer-readable medium, such as a tangible electronic, magnetic, optical, infrared, electromagnetic, and/or semiconductor system, apparatus, and/or device. For example, in some embodiments, the non-transitory computer-readable medium includes a tangible medium such as a portable computer diskette, a hard disk, a random access memory (RAM), a read-only memory (ROM), an erasable programmable read-only memory (EPROM or Flash memory), a compact disc read-only memory (CD-ROM), and/or some other tangible optical and/or magnetic storage device. In other embodiments of the present invention, however, the computer-readable medium may be transitory, such as a propagation signal including computer-executable program code portions embodied therein.

It will also be understood that one or more computer-executable program code portions for carrying out the specialized operations of the present invention may be required on the specialized computer include object-oriented, scripted, and/or unscripted programming languages, such as, for example, Java, Perl, Smalltalk, C++, SAS, SQL, Python, Objective C, and/or the like. In some embodiments, the one or more computer-executable program code portions for carrying out operations of embodiments of the present invention are written in conventional procedural programming languages, such as the “C” programming languages and/or similar programming languages. The computer program code may alternatively or additionally be written in one or more multi-paradigm programming languages, such as, for example, F #.

It will further be understood that some embodiments of the present invention are described herein with reference to flowchart illustrations and/or block diagrams of systems, methods, and/or computer program products. It will be understood that each block included in the flowchart illustrations and/or block diagrams, and combinations of blocks included in the flowchart illustrations and/or block diagrams, may be implemented by one or more computer-executable program code portions. These one or more computer-executable program code portions may be provided to a processor of a special purpose computer for the authorization and instant integration of credit cards to a digital wallet, and/or some other programmable data processing apparatus in order to produce a particular machine, such that the one or more computer-executable program code portions, which execute via the processor of the computer and/or other programmable data processing apparatus, create mechanisms for implementing the steps and/or functions represented by the flowchart(s) and/or block diagram block(s).

It will also be understood that the one or more computer-executable program code portions may be stored in a transitory or non-transitory computer-readable medium (e.g., a memory, and the like) that can direct a computer and/or other programmable data processing apparatus to function in a particular manner, such that the computer-executable program code portions stored in the computer-readable medium produce an article of manufacture, including instruction mechanisms which implement the steps and/or functions specified in the flowchart(s) and/or block diagram block(s).

The one or more computer-executable program code portions may also be loaded onto a computer and/or other programmable data processing apparatus to cause a series of optional steps to be performed on the computer and/or other programmable apparatus. In some embodiments, this produces a computer-implemented process such that the one or more computer-executable program code portions which execute on the computer and/or other programmable apparatus provide operational steps to implement the steps specified in the flowchart(s) and/or the functions specified in the block diagram block(s). Alternatively, computer-implemented steps may be combined with operator and/or human-implemented steps in order to carry out an embodiment of the present invention.

While certain exemplary embodiments have been described and shown in the accompanying drawings, it is to be understood that such embodiments are merely illustrative of, and not restrictive on, the broad invention, and that this invention not be limited to the specific constructions and arrangements shown and described, since various other changes, combinations, omissions, modifications and substitutions, in addition to those set forth in the above paragraphs, are possible. Those skilled in the art will appreciate that various adaptations and modifications of the just described embodiments can be configured without departing from the scope and spirit of the invention. Therefore, it is to be understood that, within the scope of the appended claims, the invention may be practiced other than as specifically described herein.

What is claimed is:

1. A system for intelligent perishable tracking engine, the system comprising:
a plurality of nodes participating in a distributed register network comprising a plurality of distributed registers, the plurality of distributed registers; and
a controller assigned for managing regulation of the distributed register network, the controller comprising at least one memory device with computer-readable program code stored thereon, at least one communication device connected to a network, and at least one processing device, wherein the at least one processing device is configured to execute the computer-readable program code to:
identify entities distributing perishables to one or more users;
authenticate the entities and the one or more users to a distributed register of the plurality of distributed registers associated with the intelligent perishable tracking engine and link the entities with the one or more users receiving the perishables;
assign each of the one or more users and each distribution vehicle to a node of the plurality of nodes;
generate a consensus block on the distributed register identifying a time and location of the perishables being distributed to the one or more users;
provide graphical platform for the one or more users and the entities to visualize the distributed register and a real-time location of the perishables in transit;
perform learning analytics to the distributed registers of previous perishable transportations; and
generate data routing configurations and schedules for future perishable distributions including routing and delivery logistics.

2. The system of claim 1, wherein generating data routing configurations and schedules for future perishable distributions including routing and delivery logistics comprises delivery of the perishable to the user, wherein the perishable has an extended shelf-life based on the routing and delivery logistics.

3. The system of claim 1, wherein generating the consensus block on the distributed register identifying a time and location of the perishables being distributed to the one or more users, further comprises generating a consensus block based on a time interval and mileage interval of the distribution vehicle.

4. The system of claim 1, wherein a consensus block is generated by the distribution vehicle confirming a location and one or more individuals confirming the distribution vehicle location via visualization or location monitoring of the distribution vehicle.

5. The system of claim 1, wherein linking the entities with the one or more users receiving the perishables further comprises linking the entities, the one or more users, and the distribution vehicle for delivery of the perishables into the distributed register, wherein the distributed register is a private distributed register accessible by only the entities, the one or more users, and the distribution vehicle associated with delivery of the perishables.

6. The system of claim 1, wherein the distribution vehicle is assigned to transport the perishables from the entity to one or more users.

7. The system of claim 1, wherein generating a consensus further comprises receiving a request requiring immediate review and consensus for posting further comprises receiving a request for posting a transaction on a private distributed resister network system.

8. The system of claim 1, wherein learning analytics further comprise an artificial intelligence (AI) data aggregator engine to dynamically identify data routing configurations and schedules for deliver logistics.

9. A computer program product for intelligent perishable tracking engine, the computer program product comprising at least one non-transitory computer-readable medium having computer-readable program code portions embodied therein, the computer-readable program code portions comprising:
an executable portion configured for identifying entities distributing perishables to one or more users;
an executable portion configured for authenticating the entities and the one or more users to a distributed register of the plurality of distributed registers associated with the intelligent perishable tracking engine and link the entities with the one or more users receiving the perishables;
an executable portion configured for assigning each of the one or more users and each distribution vehicle to a node of the plurality of nodes;
an executable portion configured for generating a consensus block on the distributed register identifying a time and location of the perishables being distributed to the one or more users;
an executable portion configured for providing graphical platform for the one or more users and the entities to visualize the distributed register and a real-time location of the perishables in transit;
an executable portion configured for performing learning analytics to the distributed registers of previous perishable transportations; and
an executable portion configured for generating data routing configurations and schedules for future perishable distributions including routing and delivery logistics.

10. The computer program product of claim 9, wherein generating data routing configurations and schedules for future perishable distributions including routing and delivery logistics comprises delivery of the perishable to the user, wherein the perishable has an extended shelf-life based on the routing and delivery logistics.

11. The computer program product of claim 9, wherein generating the consensus block on the distributed register identifying a time and location of the perishables being distributed to the one or more users, further comprises generating a consensus block based on a time interval and mileage interval of the distribution vehicle.

12. The computer program product of claim 9, wherein a consensus block is generated by the distribution vehicle confirming a location and one or more individuals confirming the distribution vehicle location via visualization or location monitoring of the distribution vehicle.

13. The computer program product of claim 9, wherein linking the entities with the one or more users receiving the perishables further comprises linking the entities, the one or more users, and the distribution vehicle for delivery of the perishables into the distributed register, wherein the distributed register is a private distributed register accessible by only the entities, the one or more users, and the distribution vehicle associated with delivery of the perishables.

14. The computer program product of claim 9, wherein the distribution vehicle is assigned to transport the perishables from the entity to one or more users.

15. The computer program product of claim 9, wherein generating a consensus further comprises receiving a request requiring immediate review and consensus for posting further comprises receiving a request for posting a transaction on a private distributed resister network system.

16. The computer program product of claim 9, wherein learning analytics further comprise an artificial intelligence (AI) data aggregator engine to dynamically identify data routing configurations and schedules for deliver logistics

17. A computer-implemented method for intelligent perishable tracking engine, the method comprising:
providing a computing system comprising a computer processing device and a non-transitory computer readable medium, where the computer readable medium comprises configured computer program instruction code, such that when said instruction code is operated by said computer processing device, said computer processing device performs the following operations:
identifying entities distributing perishables to one or more users;
authenticating the entities and the one or more users to a distributed register of the plurality of distributed registers associated with the intelligent perishable tracking engine and link the entities with the one or more users receiving the perishables;
assigning each of the one or more users and each distribution vehicle to a node of the plurality of nodes;
generating a consensus block on the distributed register identifying a time and location of the perishables being distributed to the one or more users;
providing graphical platform for the one or more users and the entities to visualize the distributed register and a real-time location of the perishables in transit;
performing learning analytics to the distributed registers of previous perishable transportations; and
generating data routing configurations and schedules for future perishable distributions including routing and delivery logistics.

18. The computer-implemented method of claim 17, wherein generating data routing configurations and schedules for future perishable distributions including routing and delivery logistics comprises delivery of the perishable to the user, wherein the perishable has an extended shelf-life based on the routing and delivery logistics.

19. The computer-implemented method of claim 17, wherein generating the consensus block on the distributed register identifying a time and location of the perishables being distributed to the one or more users, further comprises generating a consensus block based on a time interval and mileage interval of the distribution vehicle.

20. The computer-implemented method of claim 17, wherein linking the entities with the one or more users receiving the perishables further comprises linking the entities, the one or more users, and the distribution vehicle for delivery of the perishables into the distributed register, wherein the distributed register is a private distributed register accessible by only the entities, the one or more users, and the distribution vehicle associated with delivery of the perishables.
